(19) United States
(12) Patent Application Publication
(10) Pub. No.: US 2025/0285236 A1
(43) Pub. Date: Sep. 11, 2025

(54) 3D GAUSSIAN DIFFUSION FOR SINGLE-VIEW RECONSTRUCTION

(71) Applicants: Yuxuan MU, Edmonton (CA); Xinxin ZUO, Edmonton (CA); Peng DAI, Markham (CA); Juwei LU, Markham (CA)

(72) Inventors: Yuxuan MU, Edmonton (CA); Xinxin ZUO, Edmonton (CA); Peng DAI, Markham (CA); Juwei LU, Markham (CA)

(21) Appl. No.: 18/908,551

(22) Filed: Oct. 7, 2024

Related U.S. Application Data
(60) Provisional application No. 63/561,911, filed on Mar. 6, 2024.

(51) Int. Cl. G06T 5/70; G06T 5/50

(52) U.S. Cl. CPC G06T 5/70; G06T 5/50

(57) ABSTRACT

Methods, devices, and processor-readable media for method for performing a 3D reconstruction from a single view image, comprising progressively denoising a randomly initialized set of 3D-gaussian representations with continuous guidance from an input image.

### RELATED APPLICATION DATA

This application claims benefit and priority to U.S. provisional patent application No. 63/561,911 filed Mar. 6, 2024, the content of which is incorporated herein by reference.

### FIELD

The present application generally relates to systems, models, and computer programs for image processing and in particular to 3D Gaussian Diffusion for Single-View Reconstruction.

### BACKGROUND

Given the abundance of image data in the real world, the problem of 3D reconstruction from single-view images has garnered notable attention. 3D asset reconstruction has been in high demand for a variety of applications, including AR/VR, animation, architecture, and robotics. Moreover, 3D object reconstruction from single-view is further attuned to the feasibility of these applications, especially on mobile device such as cell phone, monocular camera and surveillance cameras. While humans can effortlessly deduce the general object shape and even imagine its texture from unseen views, for computational models, the problem becomes highly non-trivial.

There are three key aspects that underpins the single-view reconstruction problem. First, a proper 3D representation should be capable of encoding high-fidelity 3D information, while being compatible with various levels of quantization. Second, akin to the human perception system, a generative model should be able to produce an object with diverse 3D appearances of the object's back side and be faithful to the input image rendered from the same 2D view. Finally, it should be possible to efficiently and precisely render a 3D object into an arbitrary view.

Known image processing solutions include:
A. A large number of related works are directed towards reconstructing the explicit or implicit 3D representation by jointly modeling the unconditional 3D priors and the conditional distribution with a generative model [References 1,2,3 (reference documents are listed below)].
B. Another trend is solutions that turn the 3D reconstruction task into a novel view synthesis (NVS) problem [References 6,7,8]. These solutions typically use synthesis of consistent novel views of the given object and extract the 3D representation from the synthetic multi-view images.
C. Optimization-based methods that take advantage of a 2D foundation model. Most of these methods distill the 3D implicit representation from pre-trained image generation model by Score Distillation Sampling (SDS) [Reference 9].

Disadvantages of the known image processing solutions include:
A. Some of the known solutions working on explicit 3D representations [e.g., References 1,3,4] can recover explicit geometry but fail to synthesize photorealistic views. In other proposed solutions [e.g., Reference 2], the use of advanced implicit representations enables photo-quality view synthesis while struggling to extract accurate geometry in unconstrained space. Moreover, most of the previous works perceive the given view globally by using an image encoder [e.g., Reference 2,3], which cannot ensure faithful reconstruction due to the compression and also requires canonical coordinates to constrain the modeling space.
B. Current Novel View Synthesis (NVS) based solutions are becoming progressively close to the 3D reconstruction task. One of the most significant shortcomings is the 3D inconsistency issue that results from a shortage of 3D geometry priors. To address this problem, some known solutions try to apply multi-view geometry [See References 5,6], and clues from large multi-view 2D datasets. However, these solutions primarily focus on imaging geometry awareness rather than modeling the prior distribution of 3D shapes. This 2D objective deviates from 3D reconstruction, potentially resulting in unsatisfactory 3D geometry.
C. One of the primary weaknesses of score distillation sampling (SDS) lies in 3D geometry, despite involving multi-view geometry to regress the 3D representation. Firstly, SDS process is time consuming due to its long optimization process. Secondly, these approaches heavily rely on the consistent performance of large pre-trained image models, where views are treated as independent during pre-training. This can lead to the multi-face problem. Another issue arises when applying these methods to the 3D object reconstruction scenario, as the 3D space should ideally be well-constrained. Achieving alignment in a real-world setting is challenging, and thus the 3D asset creation approaches may not easily adapt to practical applications in real-world object reconstruction.

Accordingly, there is a need for methods and systems that can address at least some of the shortcomings noted above.

### SUMMARY

According to a first example aspect, a method is provided for performing a 3D reconstruction from a single view image, comprising progressively denoising a randomly initialized set of 3D-gaussian representations with continuous guidance from an input image.

According to a second example aspect, a computer implemented method is disclosed for generating a three-dimensional (3D) representation from a single-view two-dimensional image of an object. The methods includes obtaining a set of randomly initialized 3D Gaussian representations and progressively denoising the set of randomly initialized 3D Gaussian representations based on the single-view two-dimensional image of the object to obtain a refined set of 3D Gaussian representations. The refined set of the 3D Gaussian representations of the object are stored as the 3D representation of the object.

In some examples of the second aspect, progressively denoising the set of randomly initialized 3D Gaussian representations comprises performing a plurality of denoising steps that include a first denoising step, a plurality of intermediate denoising steps, and a final denoising step. At least some of the intermediate denoising steps each include: receiving an input set of 3D Gaussian representations that have been output by a preceding denoising step in the plurality of denoising steps; applying a denoising function to the input set of 3D Gaussian representations to generate a first intermediate set of 3D Gaussian representations; diffusing the intermediate set of 3D Gaussian representations to add Gaussian noise thereto to generate a second intermediate set of Gaussian representations; applying the denoising function to the second intermediate set of Gaussian representations to obtain a third intermediate set of Gaussian representations; applying a splatting function to the third intermediate set of Gaussian representations to render one or more synthetic images; comparing the one or more synthetic images to the single-view two-dimensional image of the object; computing gradients based on the comparison with an objective that includes minimizing differences between the synthetic image and the one or more single-view two-dimensional images of the object; and providing an output set of 3D Gaussian representations by adjusting at least some of the Gaussian representations included in the second intermediate set of Gaussian representations based on the computed gradients.

In one or more of the preceding examples, at least some of the intermediate denoising steps further include: comparing the one or more synthetic images to a set of auxiliary images, wherein the gradients are computed also based on the comparison of the one or more synthetic images to the set of auxiliary images.

In one or more of the preceding examples, the method includes generating the set of auxiliary images by: applying the splatting function multiple times to an output set of Gaussian representations provided by a denoising step of the at least some of the intermediate denoising steps to render a set of images; applying an image diffusion function to the set of images to generate the set of auxiliary images.

In one or more of the preceding examples, the method includes regenerating the set of auxiliary images by: applying the splatting function multiple times to an output set of Gaussian representations provided by a further denoising step of the at least some of the intermediate denoising steps to render a further set of images; applying the image diffusion function to the further set of images to regenerate the set of auxiliary images. In some examples, the regenerating is performed periodically during the performing of the plurality of denoising steps, and the same set of auxiliary images is used for multiple of the intermediate denoising steps prior to a next regenerating of the set of auxiliary images.

In one or more of the preceding examples, the first denoising step includes applying the denoising function to the randomly initialized 3D Gaussian representations to generate a first set of 3D Gaussian representations; diffusing the first set of 3D Gaussian representations to add certain-level Gaussian noise thereto to generate a second set of Gaussian representations; applying the denoising function to the second set of Gaussian representations to obtain a third set of Gaussian representations; applying the splatting function to the third set of Gaussian representations to render a first synthetic image; comparing the first synthetic image to the single-view two-dimensional image of the object; computing first gradients based on the comparison with an objective that includes minimizing differences between the first synthetic image and the single-view two-dimensional image of the object; and providing a first step output set of 3D Gaussian representations by adjusting at least some of the Gaussian representations included in the second intermediate set of Gaussian representations based on the computed gradients, the first step output set being the input set of 3D Gaussian representations for a first one of the intermediate denoising steps. Further, the final denoising step comprises: applying the denoising function to the output set of 3D Gaussian representations of a final one of the intermediate denoising steps to generate a final intermediate set of 3D Gaussian representations; and diffusing the final intermediate set of 3D Gaussian representations to add zero-level Gaussian noise thereto to obtain the refined set of 3D Gaussian representations.

In one or more of the preceding examples, each of 3D Gaussian representation is a Gaussian ellipsoid represented as a respective set of features that define, for the Gaussian ellipsoid, a center position, a covariance, a regional color, and an opacity, and adjusting at least some of the Gaussian representations comprises updating one or more of the features thereof.

In one or more of the preceding examples, the set of features define the Gaussian ellipsoid within a model space having at least 16 dimensions, the center position being defined by a three dimensional center position tensor, the covariance being defined by a three dimensional scale of covariance tensor and a six dimensional rotational of covariance vector, the regional color being defined by a three dimensional vector, and the opacity being defined by a single dimensional value.

In one or more of the preceding examples, the denoising function for each denoising step is implemented using a same trained neural approximator model.

In one or more of the preceding examples, the method includes a preliminary training process of unconditionally training the neural approximator to learn to reverse the addition of Gaussian noise that is added by the diffusing.

In one or more of the preceding examples, the method includes obtaining a simulated 2D image of the object by retrieving the stored 3D representation of the object and applying the splatting function to the 3D representation corresponding to an input camera view.

According to a further example aspect, a system is disclosed that includes or more processors, and one or more memories storing machine-executable instructions thereon which, when executed by the one or more processors, cause the system to perform the method of any one of the preceding methods.

According to a further example aspect, a non-transitory processor-readable medium is disclosed having machine-executable instructions stored thereon which, when executed by one or more processors, cause the one or more processors to perform the method of any one of the preceding methods.

According to a further example aspect, computer program is disclosed that configures a computer system to perform the method of any one of the preceding methods.

According to a further example aspect, an apparatus is disclosed that is configured to perform the method of any one of the preceding methods.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

According to one aspect of this disclosure, there is provided a system comprising a node for performing any of the methods disclosed herein.

### BRIEF DESCRIPTION OF THE DRAWINGS

Reference will now be made, by way of example, to the accompanying drawings which show example embodiments of the present application, and in which:

FIG. 1 is a block diagram illustrating a single-view based 3D model reconstruction process according to an example implementation.

FIG. 2 is a block diagram illustrating an image guided sampling process used in the process of FIG. 1, according to an example implementation.

FIG. 3 is a block diagram illustrating a view diffusion process that can be applied to create multiple images for the image guided sampling process of FIG. 2.

FIG. 4 is a block diagram illustrating an iterative joint reconstruction process that can be applied to the process of FIG. 1.

FIG. 5 illustrates a guided-denoising reconstruction process according to example implementations.

FIG. 6 is a block diagram of a computer system that can be configured to implement aspects of the disclosed methods and systems.

Similar reference numerals may have been used in different FIGs to denote similar components.

### DESCRIPTION OF EXAMPLE EMBODIMENTS

Throughout this disclosure, the following terms can have the following meanings unless context requires otherwise.

Image-guidance sampling: The progressive denoising process in a diffusion-denoising model, also referred to as a “sampling process”.

While the denoising sampling process is originally unconditional, the disclosed sampling process uses gradients back propagated from a discrepancy between a given input image and an image rendered from a denoised on-the-fly 3D object to bias the unconditional intermediate denoising result to progressively push the result closer to the given object.

Among other things, the solutions disclosed herein can, in some implementations, provide one or more the following features: reconstruct objects with high fidelity in both 3D geometry and view rendering texture; enable fast feedforward reconstruction with probabilistic modeling and real-time view rendering capacity; and reconstruct objects faithful to the input view image, and provide flexibility for arbitrary number of given views.

Aspects of the disclosed can include the following. Firstly, a 3D Gaussian Splatting (3DGS) representation is adopted for single-view reconstruction task which leads to high quality in both 3D geometry and texture. The final reconstructed objects also support real-time photorealistic rendering. Secondly, the generative prior of 3DGS objects is modelled by an unconditional diffusion model which better captures the 3D data distribution of 3DGS objects. Thirdly, an image-guided denoising sampling method is provided to perceive the given image feature which enables faithful reconstruction to the input view and flexibly support single-view, sparse-view and multi-view settings.

In example implementations, the disclosed solution can be applied to any images taken in real-life as input without calibration and alignment to reconstruct the 3D asset in 3DGS representation in a short amount of time (for example, within 5 minutes). The reconstructed objects can support real-time rendering on mobile devices. To facilitate multi-view reconstruction, example implementations only need the images and corresponding relative camera poses.

Disclosed solutions can be applied to the following applications: 3D model generation, VR/AR and Game development 3D assets, Plug-in for 3D modeling software, 3D reconstruction app or cloud service, among other things.

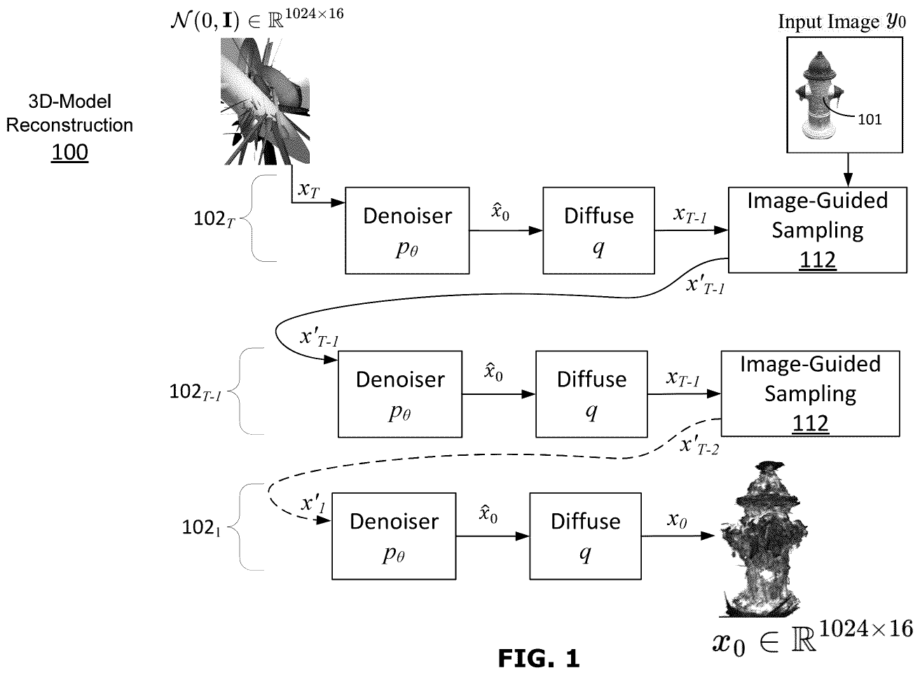

FIG. 1 illustrates a single-view based 3D-model reconstruction process 100, according to an example implementation. In the illustrated example, 3D-model reconstruction process 100 is a computer implemented process that is configured to generate a three-dimensional (3D) representation (3DGS Model x₀) from a single-view two-dimensional input image y₀ of an object 101. 3D model reconstruction process 100 includes obtaining an initialized set of randomly initialized 3D Gaussian representations [symbol] (0,I) and progressively denoising the set of randomly initialized 3D Gaussian representations [symbol] (0,I) based on the single-view two-dimensional image y₀ of the object 101 to obtain an output set of 3D Gaussian representations in the form of 3DGS Model x₀. [symbol] denotes an identity matrix.

As illustrated in FIG. 1, 3D model reconstruction process 100 includes a sequence of T denoising steps 102_{T} to 102₁, where 102_{T} is an initial denoising step and 102₁ is a final denoising step. In each denoising step 102t (where t denotes a generic denoising step and t decreases with each subsequent step) a Gaussian diffusion is performed by: (a) application of a denoising function pe (also referred to in various implementations as a denoising model, a denoiser or a neural approximator) to an input set of 3D Gaussian representations xₜ to generate a respective set of denoised 3D Gaussian representations \hat{x}₀ and (b) application of a diffuse process q to the denoised 3D Gaussian representations \hat{x}₀ to add Gaussian noise and generate a diffused set of Gaussian representations xₜ₋₁. The denoising function pe and diffuse process q of each step collectively perform a Gaussian diffusion operation.

Furthermore, each denoising step, other than final step 102₁ includes an image-guided sampling operation (also referred to as an view-guided sampling process) 112 to adjust at least some of the Gaussian representations included in the diffused set of Gaussian representations xₜ₋₁ based on an objective of minimizing differences between the single-view two-dimensional image y₀ of the object and a first synthetic image of the object generated based on the diffused set of Gaussian representations xᵢ₋₁. The resulting adjusted Gaussian representations x′ₜ₋₁ of each denoising step are provided as the input representations to the next denoising step.

In an example implementation, the denoising function pe is an unconditionally trained diffusion model. In general, a diffusion model takes Gaussian noise as input and progressively denoises it in T steps. It learns strong data priors from the denoising-diffusion process. In an example implementation, the diffusion model operates on Gaussian representations that take the form of Gaussian ellipsoids that are each represented as in a 16 dimensional three-dimensional Gaussian Splat (3DGS) model space (x∈ [symbol] ¹⁶) by a set of 3DGS features including: a center position being defined by a three dimensional ( [symbol] ³) center position tensor, a covariance being defined by a three dimensional ( [symbol] ³) scale of covariance tensor and a six dimensional ( [symbol] ⁶) rotational of covariance vector, a regional color being defined by a three dimensional ( [symbol] ³) vector, and an opacity being defined by a single dimensional value ( [symbol] ¹). In other examples, more or fewer features can be used to describe Gaussian representations.

In the illustrated example, x^{T}˜ [symbol] (x^{T};0,I) is a set of set of purely noisy Gaussian ellipsoids, and x₀˜q(x₀) is a data point sampled from the data distribution, which approximates a Gaussian ellipsoid dataset. During training, the diffuse process q is described as:

$$q ( {x}_{t} \vert {x}_{t - 1} ) = 𝒩 ( {x}_{t} ; \sqrt{1 - {β}_{t}} {x}_{t - 1} , {β}_{t} I ) , \qquad Eq . ( 1 )$$

which formulates a Markov process with a variance schedule

$${\{ {β}_{t} \}}_{t = 0}^{T}$$

that gradually adds Gaussian noise to the set of Gaussian ellipsoids \hat{x}₀. The training objective is to learn the reverse denoising process with a neural approximator p_{θ}(x₀;xₜ;t), given by denoising-diffusion objective:

$${ℒ}_{DDPM} = {𝔼}_{{x}_{0} ∼ q ( {x}_{0} ) , t ∼ [ 1 , T ]} [ {‖ {x}_{0} - {p}_{θ} ( {x}_{0} ; {x}_{t} ; t ) ‖}^{2} ] . \qquad Eq . ( 2 )$$

In an example implementation, denoising function pe can be standard transformer, which acts as a densely-connect Graph Neural Network with implicit edges realized by multi-head attention.

Operation of the 3D model reconstruction process 100 during post-training inference will now be described in greater detail.

In each denoising step 102ₜ, denoising function pe applies denoising to an input Gaussian representation x′ₜ, and a certain-level of Gaussian noise is introduced by diffuse process q to the output of the denoising function pe to provide Gaussian representations xₜ₋₁. The certain-level of Gaussian noise added at each step by diffuse process q is defined by a variance schedule, with zero-level of Gaussian noise introduced by diffuse process q at the final denoising step 102₀.

As noted above, each denoising step 102ₜ (other than final step 102₁) can include a view-guided sampling operation 112 to adjust at least some of the Gaussian representations included in the diffused set of Gaussian representations xₜ₋₁ to provide an adjusted set of Gaussian representations x′ₜ₋₁ that functions as the input for the next denoising step 102ₜ₋₁. Adjusting at least some of the Gaussian representations can include updating one of more of the 3DGS features (x∈ [symbol] ¹⁶) that are used to represent the Gaussian ellipsoids included in the diffused set of Gaussian representations xₜ₋₁

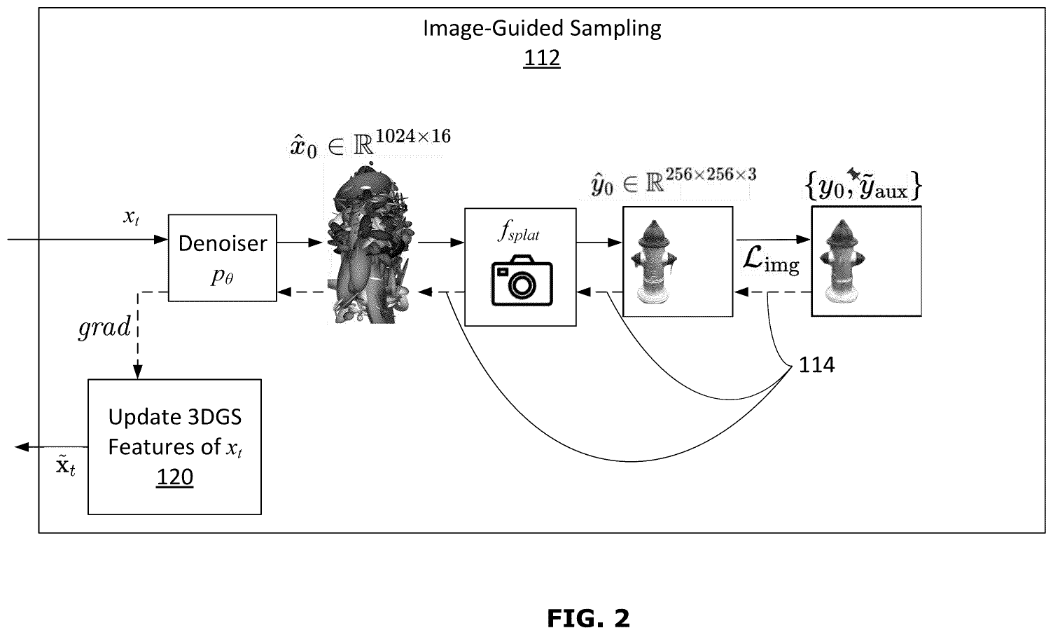

An illustrative example of an image-guided sampling operation 112 for a denoising step 102ₜ₊₁ is shown in greater detail in FIG. 2. Image-guided sampling operation 112 receives, as inputs: (a) guiding image set {y₀, \tilde{y}ₐᵤₓ} that includes at least the input image y₀ and, in some examples, a set of virtual images \tilde{y}ₐᵤₓ (described in greater detail below) and (b) the set of Gaussian ellipsoids xₜ) generated by the diffuse process q of the denoising step 102ₜ₊₁. The image-guided sampling operation 112 outputs an adjusted set of Gaussian ellipsoids \tilde{x}ₜ that have updated features based on a set of gradients (grad) generated by the image-guided sampling operation 112.

The image-guided sampling operation 112 applies the previously trained denoising function p₀ to the set of Gaussian ellipsoids xₜ to obtain a further set of Gaussian ellipsoids \hat{x}ₜ, which is then processed by a splatting function ƒₛₚₗₐₜ to generate a synthetic two-dimensional (2D) image y₀. Splatting function ƒₛₚₗₐₜ is configured to sample set the 3D model that is provided by the set of Gaussian ellipsoids \hat{x}ₜ according to an input camera view to generate a 2D projection of the object that is represented by the 3D model, thereby providing the synthetic two-dimensional (2D) image ŷ₀ that corresponds to the input camera view. The input camera view can be pre-defined or user input.

In the illustrated example, synthetic 2D image ŷ₀ has an image height and width of 256 by 256 pixels for each of 3-color channels, although other image dimensions can be used in other examples.

The synthetic 2D image ŷ₀ is then compared with the images included in the guiding image set {y₀,\tilde{y}ₐᵤₓ} using a loss function [symbol] _{img} whose objective is to minimize differences between the synthetic 2D image ŷ₀ and the images included in the guiding image set {y₀,\tilde{y}ₐᵤₓ}. Gradient values are calculated based on the output of loss function and backpropagated back through the components of the image-guided sampling operation 112 as shown by dashed arrow 114 to provide image guided gradients grad that are then applied to update the 3DGS features of the set of Gaussian ellipsoids xₜ, to generate the set of Gaussian ellipsoids \tilde{x}ₜ.

In example implementation, the loss function [symbol] _{img} includes weighted Mean Squared Error (MSE) and Structural Similarity (SSIM) components as follows:

$${ℒ}_{img} = 0.8 {ℒ}_{MSE} + 0.2 {ℒ}_{SSIM} . \qquad Eq . ( 3 )$$

Thus, image-guided sampling operation 112 projects the 3DGS model \hat{x}₀ provided by denoising function pₒ to the 2D image space through the splatting function ƒₛₚₗₐₜ and then backpropagate information back into the 3DGS model space through gradients. By way of context, in conditional generation, samples x₀ can be drawn from the prior distribution subject to certain conditions y. For a diffusion model, the conditional score at a time t can be obtained via Bayes' rule:

$${∇}_{{x}_{t}} log {p}_{t} ( {x}_{t} \vert y ) = {∇}_{{x}_{t}} log {p}_{t} ( {x}_{t} ) + {∇}_{{x}_{t}} log {p}_{t} ( y \vert {x}_{t} ) \qquad Eq . ( 4 )$$

where the first term (∇ₓ_{ₜ} log pₜ (xₜ)) is the unconditional score function ∇ₓ_{ₜ} log p_{θ} (xₜ) learned via the denoising-diffusion objective set out in Eq. (2). For the second term ∇ₓ_{ₜ} log pₜ (y|xₜ), a naive solution is to train a classifier pₜ (y|xₜ) on paired data (y|xₜ) that operates as a posterior distribution. However, a labeled dataset for noisy samples is not always available nor flexible. Accordingly, in example implementations, Diffusion Posterior Sampling (DPS) is used instead to approximate pₜ(y|xₜ) by pₜ(y|x₀) when assuming p (y|x₀) is given, where \hat{x}₀ is essentially a point estimation from the denoising function p_{θ}. Reconstruction guidance simplifies this approximation by assuming p(y|x₀) is Gaussian. Thus, pₜ(y|xₜ) becomes:

$$𝒩 [ {p}_{θ} ( {x}_{t} ) , ( \overline{β} / ( 1 - \overline{β} ) ) I ] \qquad Eq . ( 5 )$$

A differential loss function can be used to replace the mean squared error (MSE) component [symbol] _{y} of a loss function by the following:

$$\begin{matrix}DPS ( {x}_{t} , y ) & := & {∇}_{{x}_{t}} log {p}_{t} ( y \vert {\hat{x}}_{0} ) , & Eq . ( 6 ) \\ & = & {∇}_{{x}_{t}} - \frac{1 - {\overline{β}}_{t}}{2 {\overline{β}}_{t}} {‖ {x}_{0} - {\hat{x}}_{0} ‖}^{2} , & Eq . ( 7 ) \\ & = & {∇}_{{x}_{t}} - \frac{1 - {\overline{β}}_{t}}{2 {\overline{β}}_{t}} {ℓ}_{y} {\hat{x}}_{0} , & Eq . ( 8 ) .\end{matrix}$$

As image-guide sampling operation 112 uses noiseless input 2D image y₀, the approximator p_{θ}(x₀;xₜ;t) and splatting function ƒₛₚₗₐₜ can be used to compute \hat{x}₀ and y₀, forming a differentiable loss function in equation (8). Gradients w.r.t. xₜ can then be approximated as:

$$\begin{matrix}grad & ← & {∇}_{{x}_{t}} - \frac{1 - {\overline{β}}_{t}}{2 {\overline{β}}_{t}} ( {ℒ}_{img} ∘ {f}_{splat} ) ( {x}_{o} , {\hat{x}}_{0} ) , & Eq . ( 9 ) \\ & ← & {∇}_{{x}_{t}} - \frac{1 - {\overline{β}}_{t}}{2 {\overline{β}}_{t}} {ℒ}_{img} [ {y}_{0} , {f}_{splat} ( {p}_{θ} ( {x}_{o} ; {x}_{t} , t ) ) ] , & Eq . ( 10 ) \\ & & & \end{matrix}$$

where the view-point camera P is omitted in the splatting function ƒₛₚₗₐₜ(y; x, P) for simplicity. The guidance gradients then bias the unconditional score prediction by:

$${\tilde{x}}_{t} ← {\hat{x}}_{t} + {λ}_{gd} \frac{\overline{β}}{\sqrt{1 - \overline{β}}} grad , \qquad Eq . ( 11 )$$

where Δ_{gd} is an empirically a large weighting factor.

As noted above, guiding image set {y₀,\tilde{y}ₐᵤₓ} includes at least the input image y₀ and, in some examples, a set of virtual auxiliary images \tilde{y}ₐᵤₓ. In this regard, in some example embodiments, a set of virtual auxiliary images \tilde{y}ₐᵤₓ can be generated between at least some of the denoising steps 102(t) based on the set of Gaussian ellipsoids xₜ generated by a preceding step.

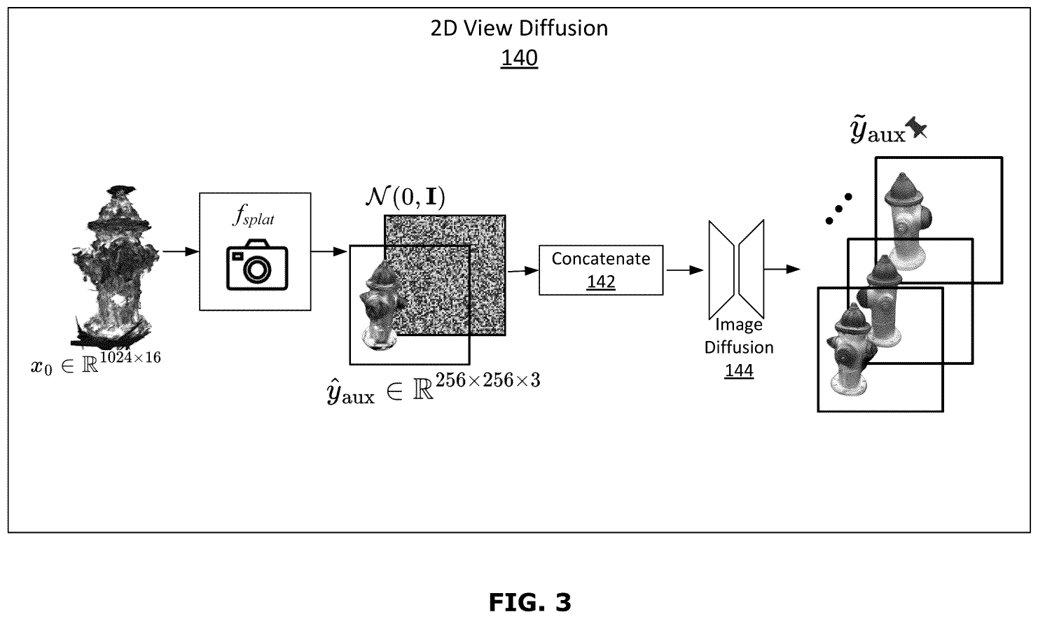

FIG. 3 illustrates a 2D view diffusion operation 140 can be periodically performed after a set of denoising steps 102t are performed. In one example, 3D model reconstruction process 100 and 2D view diffusion operation 140 are performed iteratively. In example embodiments, 2D diffusion operation 140 is used to generate a set of auxiliary images \tilde{y}ₐᵤₓ based on the most recent set of Gaussian representations x₀ generated by an iteration of the 3D model reconstruction process 100. The set of auxiliary images \tilde{y}ₐᵤₓ are then used by image-guided sampling module 112 in one or more subsequent denoising steps 102 (e.g., a subsequent iteration of the 3D model reconstruction process 100) to enhance the image-guided sampling. In this regard, FIG. 3 illustrates 2D diffusion operation 140 that can be used to take imperfect Gaussian splatting rendered 2D images and generate clean, photorealistic 2D images for the set of auxiliary images yₐᵤₓ. The 2D view diffusion operation 140 receives the 3DGS Model x₀ generated by an iteration of 3D gaussian diffusion operation 100 as an input, and applies the splatting function ƒₛₚₗₐₜ using several different camera views to project multiple 2D images ŷₐᵤₓ∈ [symbol] ^{256×256×3}. The resulting set of 2D images ŷₐᵤₓ are concatenated (Block 142) and processed by a pre-trained image diffusion model 144 to provide the set of virtual auxiliary images ŷₐᵤₓ. In some implementations, the multiple views can be relative camera views estimated based on the single input image input view using known methods like COLMAP™.

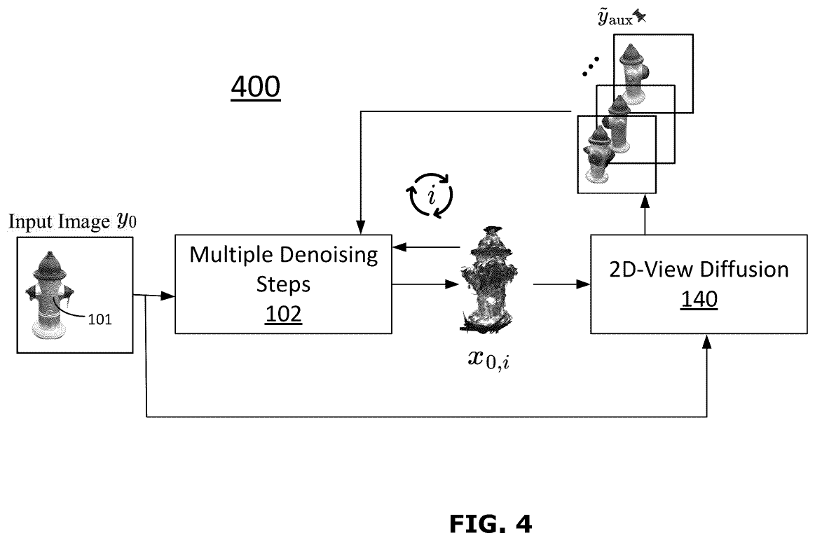

FIG. 4 is a block diagram illustrating an iterative joint reconstruction process 400 in which 3D model reconstruction process 100 and 2D view diffusion operation 140 are performed. Although all of the example of FIG. 4 shows the 3D model reconstruction process 100 and 2D view diffusion operation 140 as being eprfromed iteratively, in alternative examples, the 2D view diffusion operation 140 could also be performed at intermediate steps within the T steps of the 3D model reconstruction process 100. (e.g., the 2D view diffusion operation 140 may be performed multiple times within the 3D model reconstruction process 100 after a defined number of denoising steps 102 are performed). In the iterative joint reconstruction process 400, rendered and refined images are polished and reused via the iterative performance of the 3D model reconstruction process 100 and 2D-view diffusion operation 140. The final set of the 3D Gaussian representations (i.e., x₀ᵢ∈ [symbol] ^{1024×16}) of the object 101 generated by the final iteration of 3D model reconstruction process 100 is stored as the 3DGS Model of the object 101.

The final 3DGS model can then be used in future rendering tasks. For example, the splatting function ƒₛₚₗₐₜ can be used to generate photo-realistic 2D images (including sequences of such images) corresponding to input camera views.

A 3D reconstruction process according to example implementations can includes the following operations.

As an initial step, an unconditional diffusion model pe is trained on objects represented by 1024 3DGS ellipsoids using the loss illustrated as EQs. 1 and 2, where q represents the forward diffuse process of the diffusion model.

After training, the 3D-Gaussian ellipsoids of an object can be generated through T denoising steps of the 3D model reconstruction process 100. In particular:
(a) During inference, diffusion model pe applies image-guided sampling at each denoising step. The 3D object rendering through splatting function ƒₛₚₗₐₜ (the 3DGS rendering function) from input-view is compared with the given image using a loss function [symbol] _{img} as set out as EQ. 3. The gradients backpropagate to the diffusion model of (a) (diffusion model p_{θ}) for adjusting the sampling process, as represented in FIG. 2.
(c) A 2D diffusion model is employed to enhance the fidelity of rendered views from reconstructed 3DGS x₀, as illustrated in FIG. 3.
(d) The refined synthetic views are then reused to improved 3DGS reconstruction quality in an alternating iterative enhancement manner, as illustrated in FIG. 4.

A final reconstructed 3DGS model x₀ is obtained from the last run of the 3DGS diffusion operation 100.

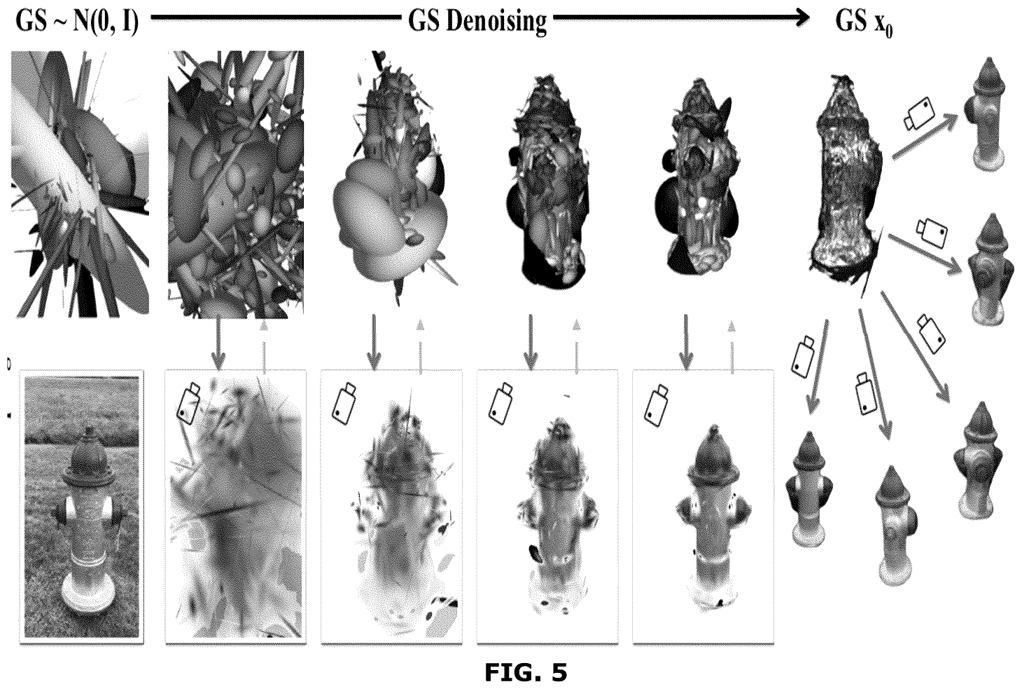

FIG. 5 shows an illustration of a guided-denoising reconstruction process in accordance with FIG. 1. The process works by progressively denoising a randomly initialized set of 3D-Gaussian ellipsoids (top row) with continuous guidance from the input 2D image (bottom row). The use of 3D-Gaussian representations provides explicit geometry information, and supports real-time and high-quality rendering of novel views.

This disclosed solution provides 3DGS for single-view reconstruction, providing, in at least some use cases, accurate 3D geometry, high-quality and real-time view rendering. Modelling of a 3DGS generative prior by diffusion model can, in some cases, provide a better geometry and texture for back side, free from the multi-face problem. The use of image-guided denoising sampling can enable a solution that is faithful to the given view and flexible to accommodate multiple given views.

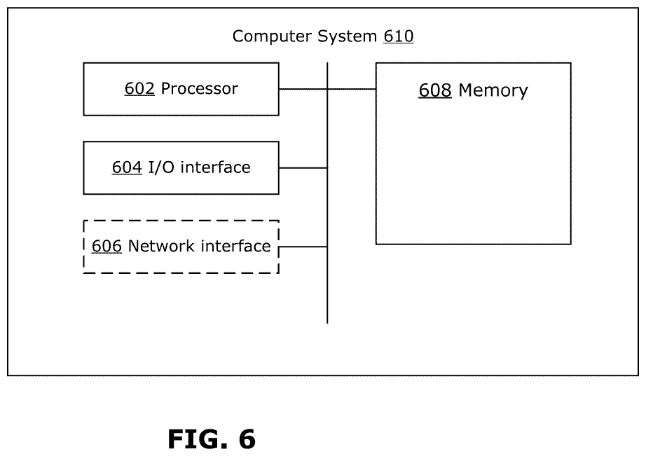

FIG. 6 illustrates an example of a computer system 610 that can be used to implement the one or more systems of the present disclosure, including for example a system that implements the operations of FIGS. 1 through 3 as part of the process of FIG. 4. Computer system 610 includes one or more processors 602, such as a central processing unit, a general processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 602 may collectively be referred to as a “processor device”. The computer system 610 also includes one or more input/output (I/O) interfaces 604, which interfaces with input devices (e.g., microphone) and output devices (e.g., speaker.

The computer system 610 can include one or more network interfaces 606 that may, for example, enable the computer system 610 to communicate with one or more further devices through a communications network such as a local area wireless network.

The computer system 610 includes one or more memories 608, which may include a volatile or non-volatile memory (e.g., a flash memory, a random access memory (RAM), and/or a read-only memory (ROM)). The non-transitory memory(ies) 608 may store instructions for execution by the processor(s) 602, such as to carry out examples described in the present disclosure. The memory(ies) 608 may include other software instructions, such as for implementing an operating system and other applications/functions. In the illustrated example, the memory 608 includes specialized software instructions 116I for implementing one or more of the solutions described herein.

In some examples, the computer system 610 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the computer system 610) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the computer system 610 may communicate with each other via a bus, for example.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The terms “substantially” and “approximately” as used in this disclosure can mean that the recited characteristic, parameter, or value need not be achieved exactly, but that deviations or variations including for example, tolerances, measurement error measurement accuracy limitations and other factors known to those skilled in the art, may occur in amounts that do not preclude the effect the characteristic was intended to provide. By way of illustration, in some examples, the terms “substantially” and “approximately”, can mean a range of within 5% of the stated characteristic.

As used herein, statements that a second item is “based on” a first item can mean that properties of the second item are affected or determined at least in part by properties of the first item. The first item can be considered an input to an operation or calculation, or a series of operations or calculations that produces the second item as an output that is not independent from the first item.

The contents of all published documents identified in this disclosure, including the documents identified below, are incorporated herein by reference.

### REFERENCES

[1] Xiaohui Zeng, Arash Vahdat, Francis Williams, Zan Gojcic, Or Litany, Sanja Fidler, and Karsten Kreis. Lion: Latent point diffusion models for 3d shape generation. arXiv preprint arXiv:2210.06978, 2022.
[2] Heewoo Jun and Alex Nichol. Shap-e: Generating conditional 3d implicit functions. arXiv preprint arXiv: 2305.02463, 2023.
[3] Alex Nichol, Heewoo Jun, Prafulla Dhariwal, Pamela Mishkin, and Mark Chen. Point-e: A system for generating 3d point clouds from complex prompts. arXiv preprint arXiv: 2212.08751, 2022.
[4] Luke Melas-Kyriazi, Christian Rupprecht, and Andrea Vedaldi. $PC\hat{ }2$: Projection-conditioned point cloud diffusion for single-image 3d reconstruction, 2023 Feb. 23.
[5] Alex Yu, Vickie Ye, Matthew Tancik, and Angjoo Kanazawa. pixelnerf: Neural radiance fields from one or few images. In Proceedings of the IEEE/CVF Conference on Computer Vision and Pattern Recognition, pages 4578-4587, 2021.
[6] Zhizhuo Zhou and Shubham Tulsiani. Sparsefusion: Distilling view-conditioned diffusion for 3d reconstruction. In Proceedings of the IEEE/CVF Conference on Computer Vision and Pattern Recognition, pages 12588-12597, 2023
[7] Jonas Kulhanek, Erik Derner, Torsten Sattler, and Robert Babuska. Viewformer: Nerf-free neural rendering from few images using transformers. In European Conference on Computer Vision, pages 198-216. Springer, 2022.
[8] Jeremy Reizenstein, Roman Shapovalov, Philipp Henzler, Luca Sbordone, Patrick Labatut, and David Novotny. Common objects in 3d: Large-scale learning and evaluation of real-life 3d category reconstruction. In Proceedings of the IEEE/CVF International Conference on Computer Vision, pages 10901-10911, 2021.
[9] Ben Poole, Ajay Jain, Jonathan T Barron, and Ben Mildenhall. Dreamfusion: Text-to-3d using 2d diffusion. In The Eleventh International Conference on Learning Representations, 2022.

1. A computer implemented method for generating a three-dimensional (3D) representation from a single-view two-dimensional image of an object, comprising:
obtaining a set of randomly initialized 3D Gaussian representations;
progressively denoising the set of randomly initialized 3D Gaussian representations based on the single-view two-dimensional image of the object to obtain a refined set of 3D Gaussian representations; and
storing the refined set of the 3D Gaussian representations of the object as the 3D representation of the object.

2. The method of claim 1 wherein progressively denoising the set of randomly initialized 3D Gaussian representations comprises performing a plurality of denoising steps that include a first denoising step, a plurality of intermediate denoising steps, and a final denoising step, wherein at least some of the intermediate denoising steps each comprise:
receiving an input set of 3D Gaussian representations that have been output by a preceding denoising step in the plurality of denoising steps;
applying a denoising function to the input set of 3D Gaussian representations to generate a first intermediate set of 3D Gaussian representations;
diffusing the intermediate set of 3D Gaussian representations to add Gaussian noise thereto to generate a second intermediate set of Gaussian representations;
applying the denoising function to the second intermediate set of Gaussian representations to obtain a third intermediate set of Gaussian representations;
applying a splatting function to the third intermediate set of Gaussian representations to render one or more synthetic images;
comparing the one or more synthetic images to the single-view two-dimensional image of the object;
computing gradients based on the comparison with an objective that includes minimizing differences between the synthetic image and the one or more single-view two-dimensional images of the object; and
providing an output set of 3D Gaussian representations by adjusting at least some of the Gaussian representations included in the second intermediate set of Gaussian representations based on the computed gradients.

3. The method of claim 2 wherein at least some of the intermediate denoising steps further comprise:
comparing the one or more synthetic images to a set of auxiliary images, wherein the gradients are computed also based on the comparison of the one or more synthetic images to the set of auxiliary images.

4. The method of claim 3 comprising generating the set of auxiliary images by:
applying the splatting function multiple times to an output set of Gaussian representations provided by a denoising step of the at least some of the intermediate denoising steps to render a set of images;
applying an image diffusion function to the set of images to generate the set of auxiliary images.

5. The method of claim 4 comprising regenerating the set of auxiliary images by:
applying the splatting function multiple times to an output set of Gaussian representations provided by a further denoising step of the at least some of the intermediate denoising steps to render a further set of images;
applying the image diffusion function to the further set of images to regenerate the set of auxiliary images.

6. The method of claim 5 wherein the regenerating is performed periodically during the performing of the plurality of denoising steps, and the same set of auxiliary images is used for multiple of the intermediate denoising steps prior to a next regenerating of the set of auxiliary images.

7. The method of claim 2 wherein:
the first denoising step comprises:
applying the denoising function to the randomly initialized 3D Gaussian representations to generate a first set of 3D Gaussian representations;
diffusing the first set of 3D Gaussian representations to add certain-level Gaussian noise thereto to generate a second set of Gaussian representations;
applying the denoising function to the second set of Gaussian representations to obtain a third set of Gaussian representations;
applying the splatting function to the third set of Gaussian representations to render a first synthetic image;
comparing the first synthetic image to the single-view two-dimensional image of the object;
computing first gradients based on the comparison with an objective that includes minimizing differences between the first synthetic image and the single-view two-dimensional image of the object; and
providing a first step output set of 3D Gaussian representations by adjusting at least some of the Gaussian representations included in the second intermediate set of Gaussian representations based on the computed gradients, the first step output set being the input set of 3D Gaussian representations for a first one of the intermediate denoising steps;
and
the final denoising step comprises:
applying the denoising function to the output set of 3D Gaussian representations of a final one of the intermediate denoising steps to generate a final intermediate set of 3D Gaussian representations; and
diffusing the final intermediate set of 3D Gaussian representations to add zero-level Gaussian noise thereto to obtain the refined set of 3D Gaussian representations.

8. The method of claim 2 wherein each 3D Gaussian representation is a Gaussian ellipsoid represented as a respective set of features that define, for the Gaussian ellipsoid, a center position, a covariance, a regional color, and an opacity, and adjusting at least some of the Gaussian representations comprises updating one or more of the features thereof.

9. The method of claim 8 wherein the set of features define the Gaussian ellipsoid within a model space having at least 16 dimensions, the center position being defined by a three dimensional center position tensor, the covariance being defined by a three dimensional scale of covariance tensor and a six dimensional rotational of covariance vector, the regional color being defined by a three dimensional vector, and the opacity being defined by a single dimensional value.

10. The method of claim 8 wherein the denoising function for each denoising step is implemented using a same trained neural approximator model.

11. The method of claim 10 comprising a preliminary training process of unconditionally training the neural approximator to learn to reverse the addition of Gaussian noise that is added by the diffusing.

12. The method of claim 2 further comprising obtaining a simulated 2D image of the object by retrieving the stored 3D representation of the object and applying the splatting function to the 3D representation corresponding to an input camera view.

13. A system, comprising:
one or more processors, and one or more memories storing machine-executable instructions thereon which, when executed by the one or more processors, cause the system to generate a three-dimensional (3D) representation from a single-view two-dimensional image of an object by:
obtaining a set of randomly initialized 3D Gaussian representations;
progressively denoising the set of randomly initialized 3D Gaussian representations based on the single-view two-dimensional image of the object to obtain a refined set of 3D Gaussian representations; and
storing the refined set of the 3D Gaussian representations of the object as the 3D representation of the object.

14. The system of claim 13 wherein progressively denoising the set of randomly initialized 3D Gaussian representations comprises performing a plurality of denoising steps that include a first denoising step, a plurality of intermediate denoising steps, and a final denoising step, wherein at least some of the intermediate denoising steps each comprise:
receiving an input set of 3D Gaussian representations that have been output by a preceding denoising step in the plurality of denoising steps;
applying a denoising function to the input set of 3D Gaussian representations to generate a first intermediate set of 3D Gaussian representations;
diffusing the intermediate set of 3D Gaussian representations to add Gaussian noise thereto to generate a second intermediate set of Gaussian representations;
applying the denoising function to the second intermediate set of Gaussian representations to obtain a third intermediate set of Gaussian representations;
applying a splatting function to the third intermediate set of Gaussian representations to render one or more synthetic images;
comparing the one or more synthetic images to the single-view two-dimensional image of the object;
computing gradients based on the comparison with an objective that includes minimizing differences between the synthetic image and the one or more single-view two-dimensional images of the object; and
providing an output set of 3D Gaussian representations by adjusting at least some of the Gaussian representations included in the second intermediate set of Gaussian representations based on the computed gradients.

15. The system of claim 14 wherein at least some of the intermediate denoising steps further comprise:
comparing the one or more synthetic images to a set of auxiliary images, wherein the gradients are computed also based on the comparison of the one or more synthetic images to the set of auxiliary images.

16. The system of claim 15 wherein the system is caused to obtain the set of auxiliary images by:
applying the splatting function multiple times to an output set of Gaussian representations provided by a denoising step of the at least some of the intermediate denoising steps to render a set of images;
applying an image diffusion function to the set of images to generate the set of auxiliary images.

17. The system of claim 16 wherein the system is caused to perform regenerating of the set of auxiliary images by:
applying the splatting function multiple times to an output set of Gaussian representations provided by a further denoising step of the at least some of the intermediate denoising steps to render a further set of images; and
applying the image diffusion function to the further set of images to regenerate the set of auxiliary images.

18. The system of claim 14 wherein:
the first denoising step comprises:
applying the denoising function to the randomly initialized 3D Gaussian representations to generate a first set of 3D Gaussian representations;
diffusing the first set of 3D Gaussian representations to add certain-level Gaussian noise thereto to generate a second set of Gaussian representations;
applying the denoising function to the second set of Gaussian representations to obtain a third set of Gaussian representations;
applying the splatting function to the third set of Gaussian representations to render a first synthetic image;
comparing the first synthetic image to the single-view two-dimensional image of the object;
computing first gradients based on the comparison with an objective that includes minimizing differences between the first synthetic image and the single-view two-dimensional image of the object; and
providing a first step output set of 3D Gaussian representations by adjusting at least some of the Gaussian representations included in the second intermediate set of Gaussian representations based on the computed gradients, the first step output set being the input set of 3D Gaussian representations for a first one of the intermediate denoising steps;
and
the final denoising step comprises:
applying the denoising function to the output set of 3D Gaussian representations of a final one of the intermediate denoising steps to generate a final intermediate set of 3D Gaussian representations; and
diffusing the final intermediate set of 3D Gaussian representations to add zero-level Gaussian noise thereto to obtain the refined set of 3D Gaussian representations.

19. The system of claim 14 wherein each 3D Gaussian representation is a Gaussian ellipsoid represented as a respective set of features that define, for the Gaussian ellipsoid, a center position, a covariance, a regional color, and an opacity, and adjusting at least some of the Gaussian representations comprises updating one or more of the features thereof.

20. A non-transitory processor-readable medium having machine-executable instructions stored thereon which, when executed by one or more processors, cause the one or more processors to perform a method for generating a three-dimensional (3D) representation from a single-view two-dimensional image of an object, comprising:
obtaining a set of randomly initialized 3D Gaussian representations;
progressively denoising the set of randomly initialized 3D Gaussian representations based on the single-view two-dimensional image of the object to obtain a refined set of 3D Gaussian representations; and
storing the refined set of the 3D Gaussian representations of the object as the 3D representation of the object.
